(19) United States
(12) Patent Application Publication
(10) Pub. No.: US 2003/0156844 A1
(43) Pub. Date: Aug. 21, 2003

(54) Communications device and communications system

(76) Inventor: Hitoshi Naoe, Kitakatsuragi-gun (JP)

Correspondence Address: BIRCH STEWART KOLASCH & BIRCH, PO BOX 747, FALLS CHURCH, VA, 22040-0747, US

(21) Appl. No.: 10/369,602

(22) Filed: Feb. 21, 2003

(30) Foreign Application Priority Data
Feb. 21, 2002 (JP) 2002-045344

(51) Int. Cl. H04B 10/00

(52) U.S. Cl. 398/139; 398/135

(57) ABSTRACT

A communications device of the present invention includes a single optical transceiver that carries out bi-directional communications using a single optical fiber, and a double optical transceiver that carries out bi-directional communications using two optical fibers, the single optical transceiver and the double optical transceiver being connected to a common communications control IC. This reduces both size and cost of the device, in addition to reducing the amount of delay that is caused in signal conversion between the single optical transceiver and the double optical transceiver.

### FIELD OF THE INVENTION

The present invention relates to a communications device and a communications system, using an optical fiber.

### BACKGROUND OF THE INVENTION

Recent advancement of information technology has prompted much research in building a home network for communicating various types of data, including digitized video and audio information.

For a system to communicate such video and audio data, use of optical fibers has been considered due to their wide band.

Generally, the optical fiber is used to realize bi-directional communications in two different ways: one using a single optical fiber with the light of different wavelengths for multiplexing; and one using two optical fibers to carry out bi-directional communications.

The method of communications that employs multiplexed wavelengths is widely used in backbone optical fiber communications because the use of different wavelengths in a single optical fiber allows a large amount of data to be flown. A specific example of a communications system employing such a method is shown in FIG. 7.

In the communications system shown in FIG. 7, four optical transceivers 701 through 704, respectively producing four different wavelengths (wavelengths A through D), are connected to one another via an optical fiber 711 through 713 and via optical splitters 709 and 710. The communications system also includes wavelength selecting filters 705 through 710, which enables the optical transceivers 701 through 704 to receive only desired wavelengths. That is, in this communications system, a common optical fiber is used in different systems of communications paths for multiplexing.

A drawback of this communications system however is that it requires careful designing with respect to the wavelengths of incoming and outgoing light, and the optical transceivers need to accommodate different wavelengths in the system of optical fiber. That is, two types of optical modules need to be prepared and connected for one-to-one communications.

Thus, in the method of communications that uses multiplexed wavelengths, a communications path needs to be designed for each wavelength. Further, the method requires setting a light source and a light receiver when designing the device, making it difficult to change the communications paths.

On the other hand, in a type of communications where the linkage (communications paths) is changed frequently, i.e., when the receiver of the communications is likely to be changed, two optical fibers, capable of sending and receiving the light of the same wavelength, are used for bi-directional communications (“double optical fiber communications” hereinafter).

A specific example of a communications system employing such double optical fiber communications is shown in FIG. 8.

The communications system shown in FIG. 8 includes optical transceivers 800 and 801 with two optical fibers (optical fibers 806 and 807) that are designated to send and receive light. For example, a light receiver 803 of the optical transceiver 800 is adapted to receive only the light that was sent from a light emitter 805 of the optical transceiver 801. Similarly, a light receiver 804 of the optical transceiver 801 is adapted to receive only the light that was sent from a light emitter 802 of the optical transceiver 800.

Thus, in bi-directional communications using two optical fibers, the sending path and receiving path independently use the light of the same wavelength. This is advantageous because it allows the communications units to be easily changed. That is, one can easily change the linkage (communications paths).

One standard being studied by IEEE for conveniently communicating video and audio data at homes using the two optical fibers is P1394b. The P1314b standard proposes using optical transceivers that are mated with two optical fibers (“double optical transceivers” hereinafter), using a PN connector under IEC61754-16, IEC61753-AA, and ANSI/TIA/EIA-568-A standards, or an LC connector under TIA-568, FOCIS 10 addendum of the TIA/EIA604 standards. Long distance communications are realized by the use of the double optical transceivers.

Another type of optical transceivers that are mated with two optical fibers and that comply with the P1394b standard is proposed by Toshiba Corporation, Hitachi Cable, Ltd., Matsushita Electric Industrial, Co., Ltd., Molex, SMK Corporation, Sony Corporation, and Taiko Electronics, Co., Ltd, under the standard called SMI (Small Multimedia Interface) connector. The SMI connector is smaller in size than the PN connector.

Further, as another type of communications system that sends and receives the same wavelength, there have been proposed bi-directional communications using a single optical fiber (“single optical fiber communications” hereinafter). A specific example of a communications system that employs such single optical fiber communications is shown in FIG. 9.

The communications system shown in FIG. 9 uses a single optical fiber 906 to send and receive signals between two optical transceivers 900 and 901, so that, for example, a light receiver 903 of the optical transceiver 900 receives not only light from a light emitter 905 of the optical transceiver 901 but also light that emerges from the light emitter 902 and reflected at various parts of the optical transceiver 900 and the optical fiber 906, including, for example, inside the optical transceiver 900, at an end face 907 of the optical fiber 906, and at an end face 908 of the optical fiber 906.

Thus, the light receiver 903 of the optical transceiver 900 cannot distinguish between incoming light, whether it is the reflected light of the light emitter 902 or the light from the light emitter 905 of the optical transceiver 901.

Further, in the optical transceiver 900, because the reflected light of the light emitter 902 becomes a noise in the light from the light emitter 905 of the optical transceiver 901, the jitter does not have a normal Gaussian distribution. This causes great difficulties in separating a clock component from the incoming light signal.

In order to solve this problem, there has been proposed OP i.LINK (registered trademark) by Sony Corporation and Sharp Corporation, as disclosed in Japanese Publication for Unexamined Patent Application Nos. 308955/2001 (Tokukai 2001-308955; published on Nov. 2, 2001), and 292195/2001 (Tokukai 2001-292195; published on Oct. 19, 2001), for example. The OP i.LINK is a modification over IEEEstd 1394a-2000 to specialize in single optical fiber communications, so that communications, which are carried out using an electrical signal through a metal wire under IEEEstd 1394a-2000, are carried out using a single optical fiber while maintaining compatibility therewith.

The foregoing single optical fiber communications and double optical fiber communications may be used to build a home network to communicate digitized video and audio data.

However, while the double optical fiber communications that comply with P1394b is suitable for communications due to their communication distance of 100 m, the requirement of two optical fibers increases the size of the connector and the thickness of the cable. This makes the double optical fiber communications unsuitable for communications between portable devices or inside the room.

On the other hand, the single optical fiber communications that comply with OP i.LINK use a small connector and require only one optical fiber of a thin cable. While this makes the single optical fiber communications suitable for communications between portable devices and inside the room, the problem of scattering outgoing light makes it difficult to carry out long distance communications. Therefore, the single optical fiber communications are not suitable for long distance communications between rooms.

That is, in a home optical fiber network, the P1394b standard is not satisfactory for the communications inside the room and the OP i.LINK causes difficulties in the communications between rooms. This raises the possibility of a communications network wherein P1394b is used between rooms and OP i.LINK is used inside the room, and wherein P1394b and OP i.LINK are allowed to communicate with each other.

Generally, optical fiber communications systems such as P1394b and OP i.LINK use different communication protocols. Thus, in a communications network in which P1394b and OP i.LINK coexist, the communications between P1394b or OP i.LINK are carried out using a communications IC of each protocol, while the communications between P1394b and OP i.LINK are carried out using a metal interface that complies with IEEEstd 1394a-2000, or by carrying out a post-process via an IC of a Link layer.

FIG. 10 shows an example of such a communications system in which P1394b and OP i.LINK coexist.

In the communications system shown in FIG. 10, a unit 1000 and a unit 1001 are connected to each other by two optical fibers 1011 to communicate, and the unit 1001 and a unit 1002 are connected to each other by a single optical fiber 1012 to communicate. In this example, the communications between the unit 1000 and the unit 1001 are between rooms, and the communications between the device 1001 and the device 1002 are inside the room.

In the communications system of the foregoing structure, the communications between the unit 1000 and the unit 1002 are carried out in the following manner. First, a double (P1394b) communications control IC 1003 of the unit 1000, using an optical transceiver that can carry out double bi-directional communications (“double optical transceiver” hereinafter), converts data into a light signal and sends it to a double optical transceiver 1008 of the unit 1001. In response, the light signal received by the double optical transceiver 1008 of the unit 1001 is sent to a double communications control IC 1004 of the unit 1001. The signal is interpreted therein and converted into an electrical signal before it is sent to a single (OP i.LINK) communications control IC 1005 in the unit 1001. In response to the input of the electrical signal, the single communications control IC 1005 interprets the signal and sends it to a single optical transceiver 1010 of the unit 1002 via a single optical fiber 1012, using an optical transceiver that can carry out single bi-directional communications (“single optical transceiver” hereinafter). The light signal received by the single optical transceiver 1010 is finally received by a single (OP i.LINK) communications control IC 1006 to complete data communication. Note that, the data transmission from the unit 1002 to the unit 1000 is just the reverse of this communication path.

One of the problems of the communications device using the single optical transceiver and the double optical transceiver is the large unit size (i.e., the size of communications device is increased), owning to the fact that the communications control IC must be provided specifically for each optical transceiver.

Further, the problem of conventional communications devices using the double optical transceiver and the single optical transceiver is the high cost of the device as a whole, associated with the provision of two communications control ICs. Thus, the communications device using the single optical transceiver and the double optical transceiver cannot avoid a large device size and an increased cost.

Further, in the communications device using the single optical transceiver and the double optical transceiver, the signal through the two optical fibers is first sent to the double optical transceiver and then converted into an electrical signal in the double communications control IC according to IEEEstd 1394a-2000, before the signal is finally converted into a signal in the single communications control IC to be sent to the single optical fiber from the single optical transceiver. Thus, in the communications device using the single optical transceiver and the double optical transceiver, the time required for the signal conversion causes a delay.

### SUMMARY OF THE INVENTION

An object of the present invention is to provide a communications device and a communications system, in which a common communications control device is used to control communications between a single optical transceiver and a double optical transceiver, so as to reduce the size of the device, and in which the communications control device controls the single optical transceiver, so as to eliminate the need to provide additional communications control devices and thereby reduces cost, in addition to reducing the amount of delay in signal conversion between the single optical transceiver and the double optical transceiver.

After extensive research to achieve the foregoing object, the inventors of the present invention have found that the communications control device that is used for an optical transceiver using a single optical fiber (“single optical transceiver” hereinafter) with a light source of the same wavelength for bi-directional communications could be suitably applied to an optical transceiver that uses separate optical fibers (two optical fibers) for the outgoing light and incoming light for bi-directional communications (“double optical transceiver” hereinafter), by taking advantage of the fact that the communications control device for the single optical transceiver is controlled to enable communications even in a setting where a single optical fiber accommodates both outgoing light and incoming light.

Accordingly, a communications device of the present invention includes: a double optical transceiver for carrying out bi-directional communications using two optical fibers with a light source of a single wavelength; and a communications control device, which controls communications of the double optical transceiver, the communications control device being used for a single optical transceiver that carries out bi-directional communications using a single optical fiber with a light source of a single wavelength.

According to this configuration, the single communications control device can be used to realize long distance communications.

Further, in a communications system in which a plurality of communications units are provided in respective rooms of a building and are connected to one another to make up a network, the communications device of the present invention may be used as connecting means for connecting the communications units.

In this case, the communication distance is different inside the room and between the rooms. However, by providing the single optical transceiver and the double optical transceiver as in the communications device of the present invention, the optical transceivers can be suitably selected according to the communication distance.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram schematically showing an example of a communications system that employs double optical fiber communications and single optical fiber communications in combination.

FIG. 2 is a block diagram schematically showing another example of the communications device of the present invention.

FIG. 3 is an explanatory drawing showing a communication band with delays.

FIG. 4(a) and FIG. 4(b) are explanatory drawings showing the number of units that can be connected according to the amount of delay.

FIG. 5 is a block diagram schematically showing a communications network in a building, using the communications device of the present invention.

FIG. 6(a) through FIG. 6(d) are cross sectional views schematically showing how a connector portion of the communications device is mounted on a wall face of the building.

FIG. 7 is a schematic drawing briefly showing optical fiber communications with multiplexed wavelengths.

FIG. 8 is a schematic drawing briefly showing double optical fiber communications using two optical fibers.

FIG. 9 is a schematic drawing briefly showing single optical fiber communications using a single optical fiber.

FIG. 10 is a block diagram schematically showing an example of a conventional communications system using double optical fiber communications and single optical fiber communications in combination.

### DESCRIPTION OF THE EMBODIMENTS

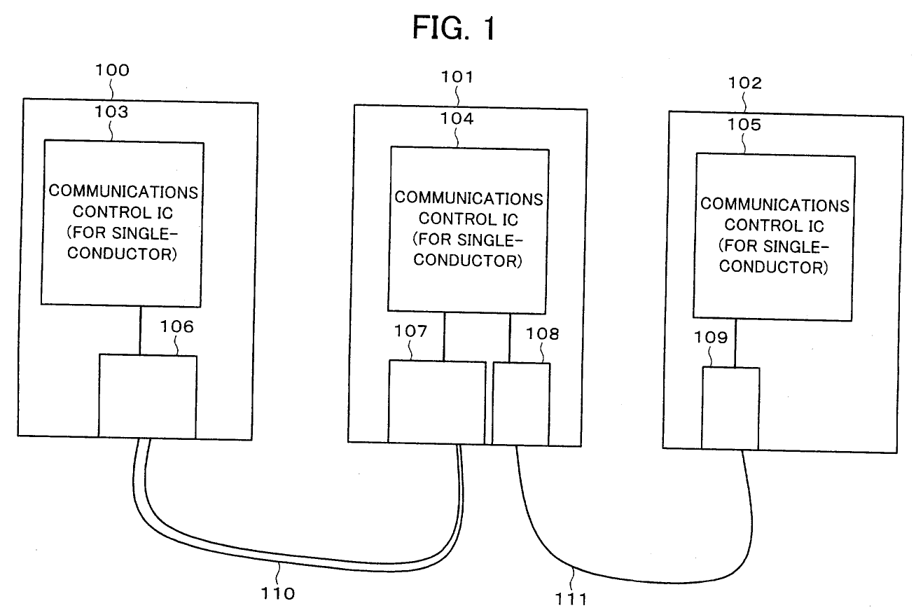

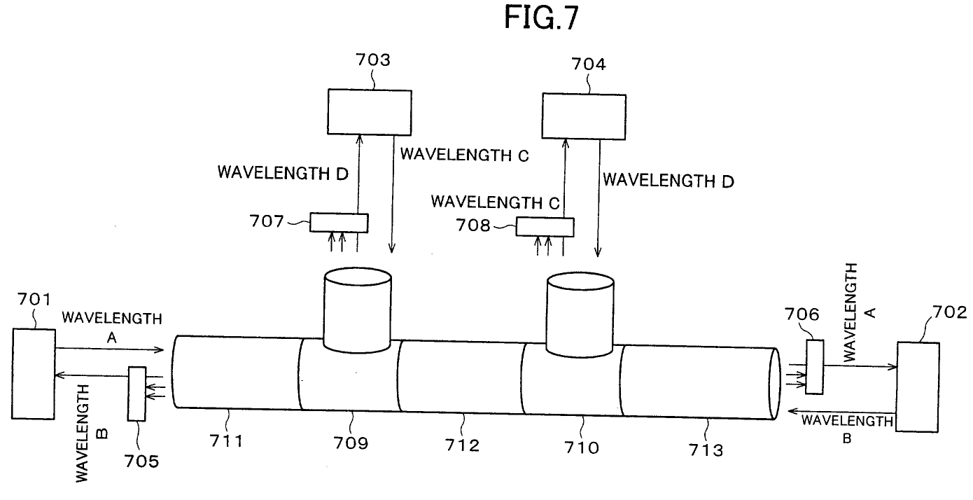

Embodiments of the present invention are described below with reference to FIG. 1 through FIG. 10.

[First Embodiment]

First, a First Embodiment of the present invention is described.

A communications system according to the First Embodiment of the present invention carries out communications between three communications devices (communications units 100 through 102) by way of double optical fiber communications and single optical fiber communications, as shown in FIG. 1.

The communications unit 100 includes a single communications control IC (communications control device) 103, which can carry out communications using optical transceivers that accommodate single bi-directional communications (“single optical transceivers” hereinafter). The communications unit 100 also includes an optical transceiver that accommodates double bi-directional communications (“double optical transceiver” hereinafter) 106.

The communications unit 101 includes a single communications control IC (communications control device) 104, which can carry out communications using single optical transceivers. The communications unit 101 also includes a double optical transceiver 107 and a single optical transceiver 108. That is, the communications unit 101 is structured to accommodate two types of optical transceivers, the double optical transceiver 107 and the single optical transceiver 108, which are connected to a single communications control IC, i.e., the communications control IC 104.

The communications unit 102 includes a single communications control IC (communications control device), which can carry out communications using single optical transceivers. The communications unit 102 also includes a single optical transceiver 109.

The communications unit 100 and the communications unit 101 are connected to each other by two optical fibers 110. To be more accurate, the two optical fibers 110 connect the double optical transceiver 106 of the communications unit 100 and the double optical transceiver 107 of the communications unit 101.

The communications unit 101 and the communications unit 102 are connected to each other by the single optical fiber 111. To be more accurate, the single optical fiber 111 connects the single optical transceiver 108 of the communications unit 101 and the single optical transceiver 109 of the communications unit 102.

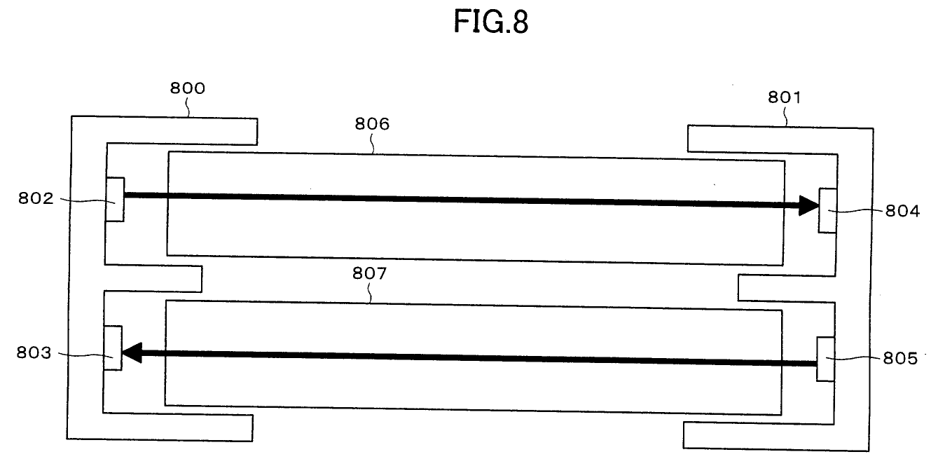

The double optical transceivers 106 and 107 have a structure of a common double optical transceiver such as a unit 800 shown in FIG. 8, wherein the two optical fibers are independently used for light transmission and light reception. The light emitter uses a light source such as LED (light emitting diode) or LD (laser diode). The light receiver uses PD (photo diode), PT (photo transistor), or similar devices.

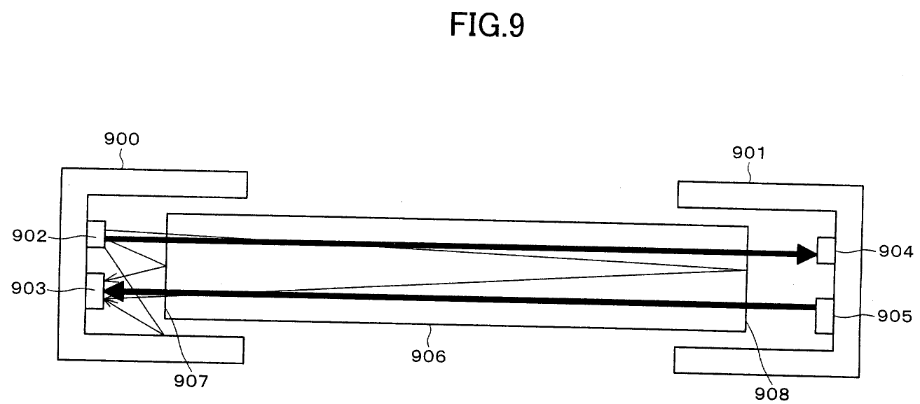

The single optical transceivers 108 and 109 have a structure of a common single optical transceiver such as a unit 900 shown in FIG. 9, wherein the light emitter and the light receiver use a single common optical fiber. As with the double optical transceivers 106 and 107, the single optical transceivers 108 and 109 also use a light source such as LED or LD for the light emitter, and a device such as PD or PT for the light receiver.

Further, the same communication protocol is used for the double optical transceivers 106 and 107 and for the single optical transceivers 108 and 109. This eliminates the need to convert one communication protocol to another, thereby reducing delays in communications.

The common communication protocol is preferably a communication protocol that complies with IEEE1394, or more preferably a communication protocol that complies with OP i.LINK under IEEE1394 standards.

The following describes operations of each unit when data is sent from the communications unit 100 to the communications unit 102 in the communications system of the foregoing structure.

First, the communications unit 100 converts data into a light signal using the communications control IC 103 and the optical transceiver 106. The light signal travels through the two optical fibers 110 to the double optical transceiver 107 of the communications unit 101 on the next stage.

The light signal received by the double optical transceiver 107 is then fed to the communications control IC 104. The communications control IC 104 interprets the signal and converts it to a light signal using the single optical transceiver 108, which is then sent through the single optical fiber 111 to the single optical transceiver 109 of the communications unit 102 on the next stage.

Finally, the light signal received by the single optical transceiver 109 is fed to the communications control IC 105, so as to finish data transmission from the communications unit 100 to the communications unit 102.

Note that, when sending data from the communications unit 102 to the communications unit 100, the transmission path of the data is the reverse of that from the communications unit 100 to the communications unit 102.

In a unit where two optical fibers are used for communications (“double optical fiber communications”) as in the communications unit 100, the use of the single communications control IC 103 allows the unit to easily communicate with a unit in which two types of optical transceivers are connected to a single communications control IC 103 that is provided for single optical fiber communications, as in the communications unit 101 in which the double optical transceiver 107 and the single optical transceiver 108 are connected to the communications control IC 104.

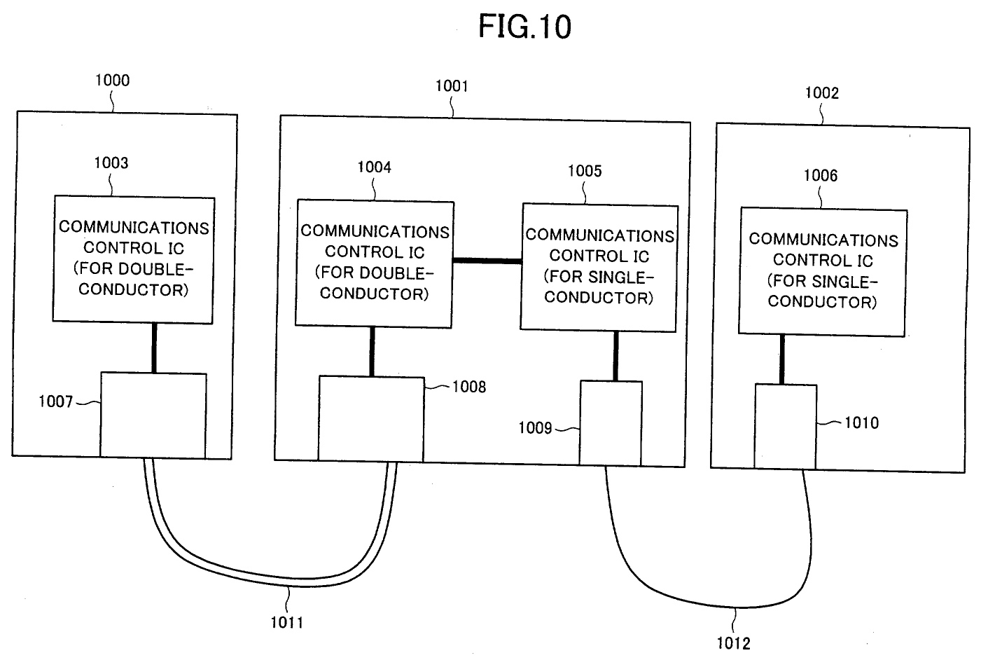

Further, the need to provide two communications control ICs for the single optical fiber communications and the double optical fiber communications as in the unit 1001 of FIG. 10 can be eliminated by controlling communications using the communications unit 101, in which the double optical transceiver 107 and the single optical transceiver 108 are connected to the communications control IC 104 that is provided for single optical fiber communications. This enables the communications units to be provided in small size and at low cost.

Further, since the light signal received by the double optical transceiver 107 is interpreted by the communications control IC 104 and converted into a light signal by the single optical transceiver 108 for transmission, no signal exchange (usually in the form of an electrical signal) between communications control ICs of double optical fiber communications and single optical fiber communications will be necessary. That is, there is no delay, which was caused conventionally in first converting the light signal into an electrical signal and then reconverting the electrical signal into a light signal.

Namely, because the light signal for double optical fiber communications is interpreted in the communications control IC and sent as a light signal for single optical fiber communications without being converted into an electrical signal, the time required for the signal conversion can be reduced by the amount of time required for the conversion of the light signal into an electrical signal and back into a light signal, between different communications systems of double optical fiber communications and single optical fiber communications.

In this manner, the communications system of the foregoing structure can have shorter delays in the data transmission of a plurality of units. The advantages and effects of shorter delays will be described later.

With the communications unit 101, the single optical fiber communications and the double optical fiber communications can easily be brought together to realize a communications system. That is, the communications unit 101, provided with the double optical transceiver 107 and the single optical transceiver 108, can be used to easily connect the communications unit 100 for double optical fiber communications and the communications unit 102 for single optical fiber communications, using the two optical fibers 110 and the single optical fiber 111, respectively.

In the communications system as structured above, the communications unit 101 can be used to carry out communications using the double optical transceiver 107 for long distance communications with a communication distance exceeding 10 m, and using the single optical transceiver 108 for short distance communications with a communication distance less than 10 m, whereby the signal is sent in each direction of the optical fiber in the double optical fiber communications to realize long distance communications, and whereby a compact communication network is realized by the short distance communications.

In this way, the communications unit 101, which accommodates both single optical fiber communications and double optical fiber communications, can be used to build a home communication network, which enables both long distance communications exceeding 10 m⁻¹ as in room-to-room communications, and short distance communications less than 10 m as in communications within a room.

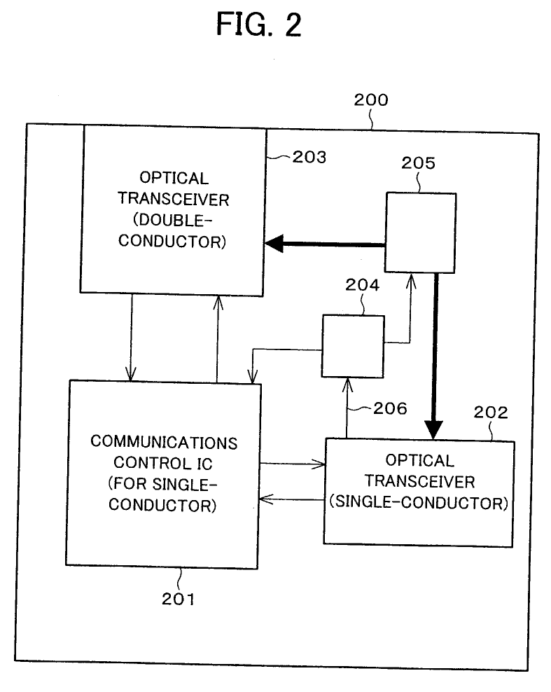

A communication unit 200 shown in FIG. 2 includes a single optical transceiver 202 and a double optical transceiver 203, which are connected to a communication control IC 201. The single optical transceiver 202 and the double optical transceiver 203 have the structures of the single optical transceiver 108 and the double optical transceiver 106, respectively. The communications control IC 201 has the same structure as the communication control IC of FIG. 1 and controls single optical fiber communications.

The communications unit 200 additionally includes a chattering removing IC 204, a transceiver power supply (power supply means) 205, and an optical fiber detecting terminal 206.

The chattering removing IC 204 is used to remove chattering in a detected signal from the optical fiber detecting terminal 206, which detects whether or not a single optical fiber has been attached to the connector with respect to the single optical transceiver 202, so as to send the detected signal to the communications control IC 201 and the transceiver power supply 205.

The transceiver 205 supplies power to the single optical transceiver 202 and the double optical transceiver 203, wherein power FETs or transistors are used to control a regulator or output of the regulator with an output enable of the power that is supplied based on the output of the chattering removing IC 204.

In response to the insertion or removal of the single optical fiber with respect to the single optical transceiver 202, the optical fiber detecting terminal 206 of the communications unit 200 of the foregoing structure generates a signal indicative of the presence or absence of the optical fiber. Immediately after the insertion or removal of the optical fiber, the signal shows chattering, which is a transient time period in which the information indicative of the presence or absence of the optical fiber is instable.

Using such an instable chattering signal directly for the control of the transceiver power supply 205 may have adverse effects on the single optical transceiver 202 and the double optical transceiver 203.

The chattering removing IC 204 is provided between the optical fiber detecting terminal 206 and the transceiver power supply 205 to prevent such adverse effects. In this way, the chattering removing IC 204 can remove chattering from the signal supplied from the optical fiber detecting terminal 206, and the signal received by the transceiver power supply 205 does not contain chattering. That is, the transceiver power supply 205 is controlled by a signal that contains no chattering.

The transceiver power supply 205 is adapted to supply power to the single optical transceiver 202 and the double optical transceiver 203 in response to signal input from the chattering removing IC 204 indicating the presence of the optical fiber. The transceiver power supply 205, on the other hand, suspends power supply to the single optical transceiver 202 and the double optical transceiver 203 in response to signal input that indicates absence of the optical fiber.

Further, the communications unit 200 is adapted to enter a power saving mode by inactivating operations of unnecessary circuits in the communications control IC 201 when the optical fiber is not inserted in the single optical transceiver 202, because, in this case, the communications control IC 201 is not required.

In the described structure of the communications unit 200 in which the single optical transceiver 202 and the double optical transceiver 203 are connected to the common communications control device, i.e., the communications control IC 201, and in which the communications device 200 serves only to carry out conversion between the single optical fiber and the two optical fibers, the communications unit 200 is used in the communications only when the single optical fiber is detected. Thus, by suspending power supply to the single optical transceiver 202 and the double optical transceiver 203 when the single optical fiber is not detected, the system can be brought into a power saving mode and the power consumption of the entire communications system can be reduced.

Further, since the operations of the single optical transceiver 202 and the double optical transceiver 203 are effected only when they are required, it is not necessary to always activate the light source (LED, LD, etc.) used for the light emitter of the each optical transceiver. This extends life of the light source and in turn life of the optical transceiver.

Note that, the foregoing described the case where the chattering removing IC 204 is separately provided from the communications control IC 201. However, the function of the chattering removing IC 204 may be incorporated in the communications control IC 201. Further, where chattering does not pose a problem, the detected signal from the optical fiber detecting terminal 206 may be directly supplied to the transceiver power supply 205, without providing the chattering removing IC 204.

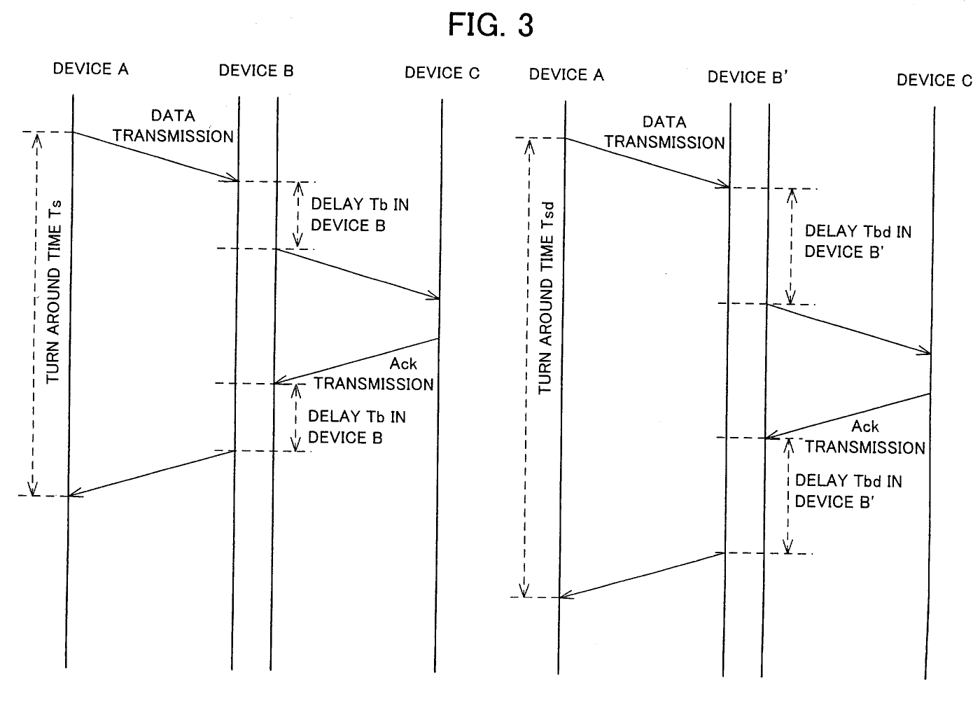

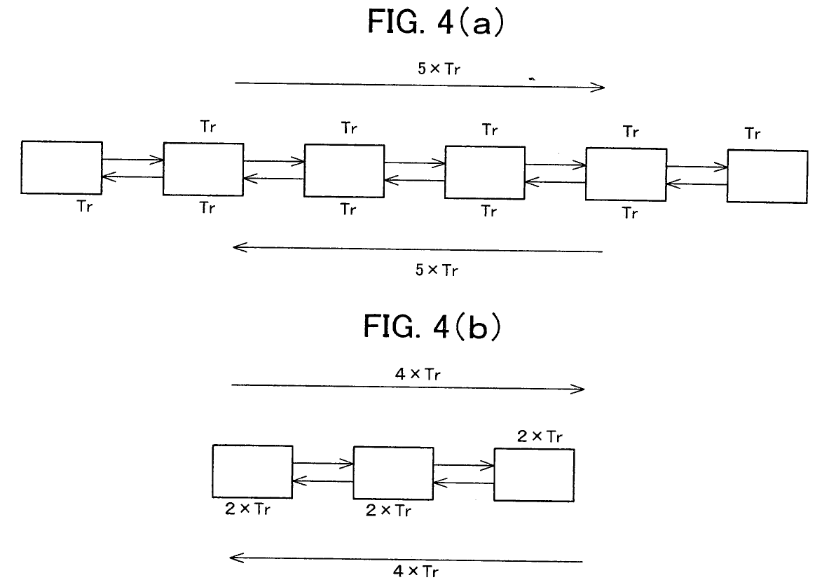

Referring to FIG. 3 and FIG. 4, the following describes effects of reducing delays in the communications system.

Under IEEE1394 standards, in a system, as shown in FIG. 3, where device A sends data to device C and device C returns a signal Ack indicative of whether or not the data has been transmitted properly, data transmission from a particular communications unit (from device A to device C in the example of FIG. 3) is prohibited for a certain period of time. More specifically, the data transmission is prohibited during the period in which the communications are processed by device B or device B′, because the communications do not complete until device A, sending the data to device C, receives the signal Ack from device C.

To this end, IEEE1394 sets GAP COUNT, which is a value used to calculate the time during which data transmission is prohibited, so as to block data transmission for a certain time period after the preceding data is transmitted with respect to the whole bus. This means that the next data cannot be transmitted for a certain period of time, for example, even when the signal Ack is returned in the communications between device A and device B.

In such a bus design, the presence of a unit such as device B′ with a long repeat delay reduces the amount of time available for outputting packets and therefore is not time efficient. As a result, the execution band of data (the amount of data that can be sent or received in a certain time period) is reduced.

Thus, time efficiency can be improved and the execution band of data can be widened by reducing the repeat delay.

Further, in the communications, as in IEEE1394, where a maximum time is set for the time required for the signal Ack to return with respect to the time the data was sent, the presence of a unit with a long delay in the bus decreases the number of units that can be linked together.

Assuming that a maximum value Tat of the time required for the signal Ack to return with respect to the data that was transmitted through devices with a delay time Tr (the time required to detect the received data and send it) satisfies 11×Tr>Tat>10×Tr, a total delay becomes 5×Tr in each path, allowing linkage of six units. (Note that, only the delays of the units are taken into account, and other delays, such as a cable delay, are ignored here.)

On the other hand, as shown in FIG. 4(b), with the units each causing a delay of 2×Tr, connecting four of these units generates a total delay of 12×Tr, roundtrip, with the result that the turn around time of the signal Ack becomes longer than Tat. Thus, only three of such units can be connected.

Therefore, in a type of communications where a maximum value is set for the turn around time of the signal Ack as in IEEE1394, reducing the amount of delay can increase the number of units that can be connected.

[Second Embodiment]

Another embodiment of the present invention is described below.

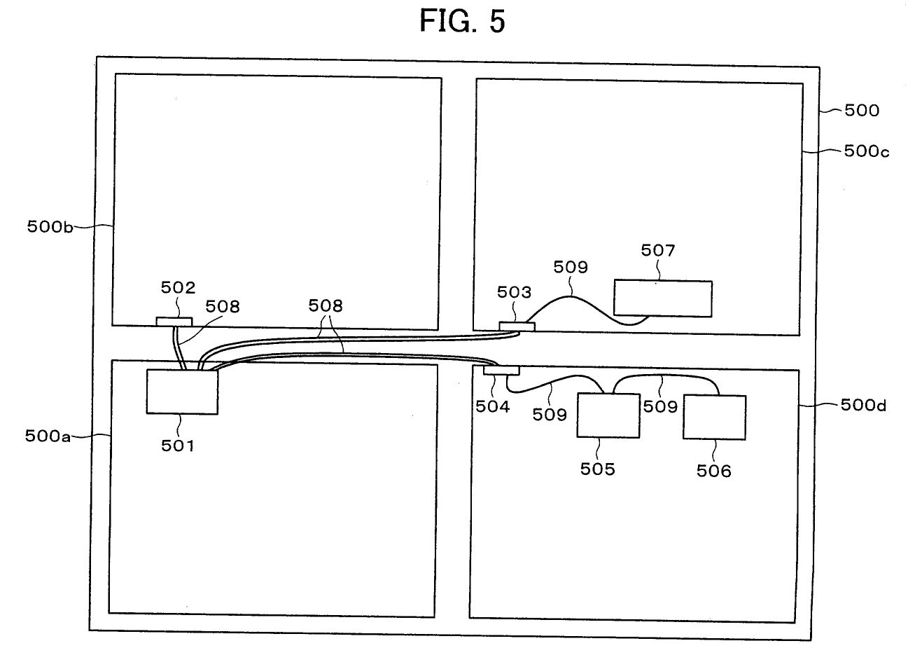

The following description is given through the case where the communications devices and communication system described in the First Embodiment are applied to a home 500 as shown in FIG. 5. It is assumed here that the home 500 has four rooms (rooms 500a through 500d).

The room 500a has a control unit 501, which manages and controls communications units provided in the other rooms.

The communications unit 501 includes a plurality of units analogous to the communications unit 100 described in the First Embodiment, i.e., the communications unit including the single communications control IC capable of bi-directional communications, and the double optical transceiver. The control unit 501, with this configuration, sends and receives data with respect to the other rooms using two optical fibers 508.

The other rooms 500b through 500d are provided with information sockets 502 through 504, respectively, each of which makes up a unit analogous to the communications unit 101 described in the First Embodiment, i.e., the communications unit in which the single optical transceiver and the double optical transceiver are connected to the single communications control IC that is capable of bi-directional communications.

The information sockets 502 through 504 have the same structure, and are provided on the walls as are electrical sockets. The double optical transceivers are provided so that the two optical fibers 508 are placed outside of the rooms for communications with the other rooms. The single optical transceivers, for communications with information units 505 through 507 using data including video data and audio data within the room, are provided so that the receptacles for the single optical fibers 509 are placed inside the rooms.

In the foregoing configuration, the two optical fibers 508 are used for long distance communications between the control unit 501 and the information sockets 502 through 504, linking the rooms. The two optical fibers 508 are provided inside the walls of the home 500, which allows the control unit 501 and the double optical transceivers of the information sockets 502 through 504 to be provided in part of the rooms where they cannot be seen.

This enables the double optical transceivers to be designed more freely, because it is not required to take into consideration the thickness of the two optical fibers 508 used for double optical fiber communications, or the size of the connecter of the double optical transceiver for inserting the two optical fibers.

For communications between information units (e.g., information unit 505) inside the room, single optical fiber communications using the single optical fiber 509 of a small dimension and a small connector size can be used.

More specifically, the control unit 501 of the room 501a uses the two optical fibers 508 to communicate with the information sockets 502 through 503 of the rooms 500b through 500d. The information socket 503 inside the room 500c uses the single optical fiber 509 to communicate with the information unit 507, and the information socket 504 inside the room 500d uses the single optical fiber 509 to communicate with the information unit 505, which also uses the single optical fiber 509 to communicate with the information unit 506.

The information socket 502 inside the room 500b is not particularly required to communicate with the control unit 501 because it is not connected to any unit. In this case, the information socket 502 may adopt a structure, as described in the First Embodiment, wherein the presence or absence of the optical fiber in the single optical transceiver is detected, so as to suspend power supply to the single optical transceiver and double optical transceiver, thereby causing the information socket 502 to enter a power saving mode.

Thus, the information socket 502, which is not in use, dissipates low power. Further, since the light source of the optical transceiver can be suspended when it is not required, the life of the optical transceiver can be extended.

The control unit 501 may be provided with a plurality of communications units, each having one double optical transceiver, as described above. Alternatively, the control unit 501 may be realized by a plurality of communications control ICs, each having a plurality of optical transceivers.

Further, the foregoing described the case where the control unit 501 is used to control home communications. However, it should be noted here that the control unit 501 is not particularly required when the respective units are simply connected to one another between the rooms. Namely, the information sockets may be simply connected to one another using the two optical fibers. This does not impede proper operations of the information sockets.

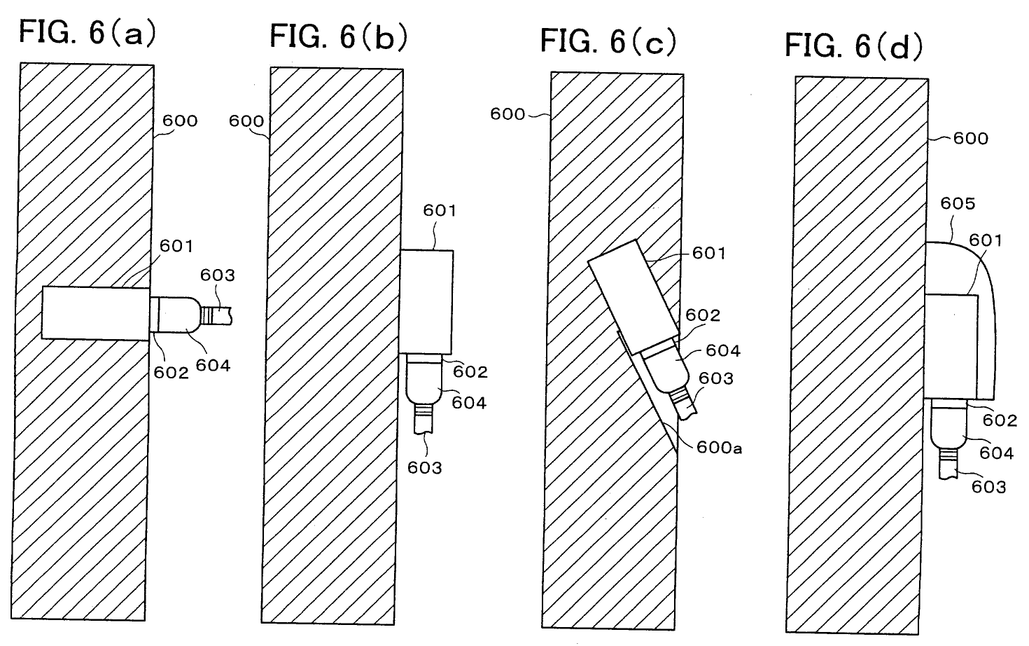

Referring to FIG. 6(a) through FIG. 6(d), the following describes a connector of the single optical transceiver with regard to its mount position on the information socket on the wall of the room.

Generally, a portion in the area of the optical fiber inserted in the optical transceiver has a strong anchoring mechanism. The high strength means susceptibility to breakage in response to a large shock. It is therefore important to consider the mount position of the optical transceiver connector for inserting the optical fiber.

The single optical fiber may be provided so that its receptacle is on the wall of the room of a construction such as a home. For example, as shown in FIG. 6(a), a connector 601 may be mounted on a wall face 600 so that the direction of insertion of an optical fiber 603 is perpendicular to the wall face 600. In this case, a large portion of a plug 604 of the optical fiber 603 inserted in a receptacle 602 of the connector 601 is exposed in a direction perpendicular to the wall face 600. This makes the optical fiber 603 susceptible to breakage when the plug 604 is subjected to external force.

In order to avoid this, the connector 601 may be provided on the wall face 600 so that the direction of insertion of the optical fiber 603 is parallel to the wall face 600, as shown in FIG. 6(b). In this case, only a small portion of the plug 604 of the optical fiber 603 inserted in the receptacle 602 of the connector 601 is exposed on the wall face 600, thus reducing the probability that the optical fiber 603 is broken.

Further, the connector 601 may be mounted so that the optical fiber 603 is inserted in the receptacle 602 of the connector 601 in an oblique direction with respect to a direction perpendicular to the wall face 600. This further reduces the probability that the optical fiber 603 is broken, as compared with the case where the optical fiber 603 is inserted perpendicular to the wall face 600.

In order to insert the optical fiber 603 in an oblique direction, rather than perpendicular direction, with respect to the wall face 600, the connector 601 may be inserted into an opening 600a within the wall face 600 in an oblique direction with respect to a direction perpendicular to the wall face 600 as shown in FIG. 6(c).

In this case, the receptacle 602 of the connector 601 is tilted with respect to a direction perpendicular to the wall face 600, and accordingly the plug 604 of the optical fiber 603 inserted in the receptacle 602 is also tilted with respect to a direction perpendicular to the wall face 600.

Further, by forming the opening 600a so that the plug 604 is concealed therein, it is possible to further reduce the probability that the optical fiber 603 inserted in the receptacle 602 of the connector 601 is broken.

Namely, by implanting the connector 601 below the wall face 600, the plug 604 of the optical fiber 603, which is susceptible to breakage, can be placed below the wall face 600, thereby further reducing the probability that the optical fiber 603 is broken.

Further, as shown in FIG. 6(d), a hood 605 may be provided over the connector 601 that is mounted on the wall face 600 as in FIG. 6(b). In this case, should an object hits, it hits the hood 605, and the plug 604 of the optical fiber 603 is protected from the shock of the impact, thereby reducing the probability that the plug 604 is broken.

In order to reduce the probability that the optical fiber 603 is broken, the insertion direction of the optical fiber 603 should be directed in a direction other than the perpendicular direction with respect to the wall face 600, as described above. More preferably, the connecter 601 should be provided so that the insertion direction of the optical fiber 603 is titled with respect to a direction perpendicular to the wall face 600.

This is for the following reasons.

For example, when the connecter 601 is provided so that the insertion direction of the optical fiber 603 is raised with respect to a direction perpendicular to the wall face 600, the probability that the optical fiber 603 is broken can be reduced as compared with the case where the optical fiber 603 is inserted perpendicular to the wall face 600. However, in this case, because the receptacle 602 of the connector 601 faces up, the receptacle 602 collects dust when the optical fiber 603 is not inserted and when the receptacle 602 is not closed. This generates an optical loss in the optical transceiver, which may prevent the optical transceiver from successfully communicating over a required distance.

It is therefore not preferable to have an upward configuration of the receptacle 602 of the connector 601 of the optical transceiver.

As described, the present invention uses a single control IC to connect a single bi-directional communication optical transceiver and a double bi-directional communication optical transceiver, so as to inexpensively realize a system that is capable of carrying out both long distance communications using a double fibers and portable communications using a single fiber.

The system of the present invention can be used to inexpensively provide information sockets that use fibers to realize home information communications.

The invention removes the conventional boundary between single optical fiber communications and double optical fiber communications, for example, in home optical fiber communications, by enabling the two types of optical fiber communications to be freely used depending on the environment (distance, size), only by switching a double optical transceiver and the single optical transceiver.

As described, a communications device of the present invention includes: one or more double optical transceivers for carrying out bi-directional communications using two optical fibers with a light source of a single wavelength; and a communications control device, which controls communications of the double optical transceiver, the communications control device being used for a single optical transceiver that carries out bi-directional communications using a single optical fiber with a light source of a single wavelength.

With this configuration, the communications control device for the single optical transceiver enables long distance communications.

The communications control device may be connected to one or more single optical transceivers.

In this case, the single optical transceiver and the double optical transceiver are connected to a single communication control device. This is advantageous because it allows, for example, a received signal of the single optical transceiver to be sent out from the double optical transceiver, and vice versa.

This makes it possible to inexpensively provide a communications device that uses the single optical transceiver and the double optical transceiver in combination.

Further, unlike a system in which separate communications control devices are used for the single optical transceiver and the double optical transceiver, the signal can be exchanged without being converted into an electrical signal, thereby eliminating the time required for the conversion into an electrical signal (i.e., eliminating the delay).

Further, in order to solve the foregoing problems, a communications device of the present invention includes a double optical transceiver, which carries out bidirectional communications using two optical fibers, and a single optical transceiver, which carries out bi-directional communications using a single optical fiber, wherein the double optical transceiver and the single optical transceiver are controlled by a common communication control device to communicate.

According to this configuration, the communications device requires only a single communications control device to control communications between the single optical transceiver and the double optical transceiver. This reduces size of the device.

Further, according to the present invention, the single optical fiber communications and the double optical fiber communications share the same protocol.

Because the same communication protocol is used by the single optical transceiver and the double optical transceiver, conversion of communication protocols is not required. This reduces the amount of delay in converting one communication protocol to another between the single communications and double communications.

The communication protocol preferably complies with IEEE1339 or more preferably OP i.LINK.

By connecting the communications IC that complies with the standards (OP i.LINK) adapted to single bi-directional communications with an optical transceiver that carries out bi-directional communications using a two optical fibers, it is possible to realize long distance communications, which was not possible by the combination of the communications IC of the OP i.LINK standards and the single bi-directional optical transceiver.

According to the foregoing configuration, long distance communications are enabled by the double optical fiber communications in which the light signal is conducted in each direction of the optical fiber, while the single optical fiber communications using only one optical fiber realizes a smaller communication system. As a result, a small communications system with a long distance communications capability can be realized.

The communications device may be adapted so that the single optical transceiver includes: detecting means for detecting whether or not an optical fiber has been attached to the single optical transceiver; and power supply control means for controlling power supply to the single optical transceiver and the double optical transceiver according to a result of detection by the detecting means,

the power supply control means suspending power supply to the single optical transceiver when the detecting means detects that the optical fiber has not been attached to the single optical transceiver.

Further, the communications device may be adapted so that the power supply control means suspends power supply to the double optical transceiver when the detecting means detects that the optical fiber has not been attached to the single optical transceiver.

Further, the communications device may be adapted so that the power supply control means suspends operations of the communications control device to reduce power consumption of the communications control device at or below a predetermined value, when the detecting means detects that the optical fiber has not been attached to the single optical transceiver.

According to this configuration, power supply to the single optical transceiver and the double optical transceiver is suspended when the detecting means detects that the optical fiber has not been attached to the single optical transceiver, i.e., when the communications device is found to be not in use. This reduces power consumption of the communications device when it is not used.

Further, in the conversion of the double optical transceiver and the single optical transceiver by the common communications control device, the double optical fiber communications are not required when the optical fiber is not connected to the single optical transceiver, nor the communications control device carrying out the conversion is required to operate. Thus, low power consumption can be achieved when communications are not required. Further, since the light source does not emit light at all times, life of the light source can be extended.

Further, in a communications system in which a plurality of communications units are provided in respective rooms of a building and are connected to one another to make up a network, the communications device of the present invention may be used as connecting means for connecting the communications units.

In this case, the communication distance is different inside the room and between the rooms. However, by providing the single optical transceiver and the double optical transceiver as in the communications device of the present invention, the optical transceivers can be suitably selected according to the communication distance.

The connecting means may be provided on the wall of the building.

By providing the connecting means in the form of an electrical socket, the user of the device can easily plug in and out the optical fiber.

The communications system may be adapted so that the connecting means includes a double connector for attaching the two optical fibers to the double optical transceiver, the double connector being provided in a wall of the room so that the two optical fibers are attached to the double optical transceiver within the wall, and the connecting means includes a single connector for attaching the single optical fiber to the single optical transceiver, the single connector being provided on a wall face of the room so that the single optical fiber is attached to the single optical transceiver on the wall face.

In this case, communications between rooms are enabled by the double communications optical fibers that are provided within the wall and the single communications optical fiber is inserted into the wall, thereby enabling communications between devices inside the room.

The communications system may be adapted so that the single connector has an optical fiber receptacle, which is adjusted so that an insertion direction of the single optical fiber to the single connector is not perpendicular to the wall face.

Further, the communications system may be adapted so that the single connector has an optical fiber receptacle, which is adjusted so that an insertion direction of the single optical fiber to the single connector is tilted with respect to a direction perpendicular to the wall face.

Further, the communications system may be adapted so that the optical fiber receptacle of the single connector is provided so that the optical fiber receptacle is not exposed on the wall face.

Further, the communications system may be adapted so that the single connector includes a protecting section in a vicinity of the optical fiber receptacle, so as to protect a portion of the single optical fiber inserted in the optical fiber receptacle.

According to the foregoing configurations, only a small portion of the connector mated with the optical fiber projects, thus preventing the problem of accidental fiber breakage. In addition, it is possible to prevent the problem of optical loss, which is caused when dust enters the connector opening when the optical fiber is not inserted in the optical transceiver.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A communications device, comprising:
one or more double optical transceivers for carrying out bi-directional communications using two optical fibers with a light source of a single wavelength; and
a communications control device, which controls communications of the double optical transceiver,
the communications control device being used for a single optical transceiver that carries out bi-directional communications using a single optical fiber with a light source of a single wavelength.

2. The communications device as set forth in claim 1, wherein the communications control device is connected to one or more single optical transceivers.

3. The communications device as set forth in claim 2, wherein:
the single optical transceiver includes:
detecting means for detecting whether or not an optical fiber has been attached to the single optical transceiver; and
power supply control means for controlling power supply to the single optical transceiver and the double optical transceiver according to a result of detection by the detecting means,
the power supply control means suspending power supply to the single optical transceiver when the detecting means detects that the optical fiber has not been attached to the single optical transceiver.

4. The communications device as set forth in claim 3, wherein the power supply control means suspends power supply to the double optical transceiver when the detecting means detects that the optical fiber has not been attached to the single optical transceiver.

5. The communications device as set forth in claim 3, wherein the power supply control means suspends operations of a circuit that is not required in the communications, so as to reduce power consumption at or below a predetermined value, when the detecting means detects that the optical fiber has not been attached to the single optical transceiver.

6. The communications device as set forth in claim 1, wherein the double optical transceiver and the single optical transceiver share a single communication protocol.

7. The communications device as set forth in claim 6, wherein the communication protocol complies with IEEE1394 standards.

8. The communications device as set forth in claim 7, wherein the communication protocol under the IEEE1394 standards complies with OP i.LINK standards.

9. A communications device, comprising:
one or more double optical transceivers, which carry out bi-directional communications using two optical fibers; and
one or more single optical transceivers, which carry out bi-directional communications using a single optical fiber,
the double optical transceiver and the single optical transceiver being controlled by a common communications control device to communicate.

10. The communications device as set forth in claim 9, wherein the double optical transceiver and the single optical transceiver share a single communication protocol.

11. The communications device as set forth in claim 10, wherein the communication protocol complies with IEEE1394 standards.

12. The communications device as set forth in claim 11, wherein the communication protocol under the IEEE1394 standards complies with OP i.LINK standards.

13. The communications device as set forth in claim 9, wherein:
the single optical transceiver includes:
detecting means for detecting whether or not an optical fiber has been attached to the single optical transceiver; and
power supply control means for controlling power supply to the single optical transceiver and the double optical transceiver according to a result of detection by the detecting means,
the power supply control means suspending power supply to the single optical transceiver when the detecting means detects that the optical fiber has not been attached to the single optical transceiver.

14. The communications device as set forth in claim 13, wherein the power supply control means suspends power supply to the double optical transceiver when the detecting means detects that the optical fiber has not been attached to the single optical transceiver.

15. The communications device as set forth in claim 13, wherein the power supply control means suspends operations of a circuit that is not required in the communications, so as to reduce power consumption at or below a predetermined value, when the detecting means detects that the optical fiber has not been attached to the single optical transceiver.

16. A communications system in which a plurality of communications units are provided in respective rooms of a building and are connected to each other to construct a network, comprising:
connecting means for connecting the communications units,
the connecting means being used as a communications device that includes:
one or more double optical transceivers for carrying out bi-directional communications using two optical fibers with a light source of a single wavelength; and
a communications control device, which controls communications of the double optical transceiver,
the communications control device being used for a single optical transceiver that carries out bi-directional communications using a single optical fiber with a light source of a single wavelength, and
the communications control device being connected to one or more single optical transceivers.

17. The communications system as set forth in claim 16, wherein the connecting means is provided in a wall of the building.

18. The communications system as set forth in claim 17, wherein:
the connecting means includes a double connector for attaching the two optical fibers to the double optical transceiver, the double connector being provided in a wall of the room so that the two optical fibers are attached to the double optical transceiver within the wall, and
the connecting means includes a single connector for attaching the single optical fiber to the single optical transceiver, the single connector being provided on a wall face of the room so that the single optical fiber is attached to the single optical transceiver on the wall face.

19. The communications system as set forth in claim 18, wherein the single connector has an optical fiber receptacle, which is adjusted so that an insertion direction of the single optical fiber to the single connector is not perpendicular to the wall face.

20. The communications system as set forth in claim 18, wherein the single connector has an optical fiber receptacle, which is adjusted so that an insertion direction of the single optical fiber to the single connector is tilted with respect to a direction perpendicular to the wall face.

21. The communications system as set forth in claim 18, wherein the optical fiber receptacle of the single connector is provided so that the optical fiber receptacle is not exposed on the wall face.

22. The communications system as set forth in claim 18, wherein the single connector includes a protecting section in a vicinity of the optical fiber receptacle, so as to protect a portion of the single optical fiber inserted in the optical fiber receptacle.
